(19) United States
(12) Patent Application Publication
(10) Pub. No.: US 2025/0286288 A1
(43) Pub. Date: Sep. 11, 2025

(54) INSULATION PIERCING CONNECTOR

(71) Applicant: Bamboo Dynamics Corporation., Ltd., Hsinchu (TW)

(72) Inventors: Yuan Chen Chan, Hsinchu (TW); Han-Ping Yang, Hsinchu County (TW)

(73) Assignee: Bamboo Dynamics Corporation., Ltd., Hsinchu (TW)

(21) Appl. No.: 18/732,643

(22) Filed: Jun. 4, 2024

Related U.S. Application Data
(60) Provisional application No. 63/561,706, filed on Mar. 5, 2024.

(51) Int. Cl. H01R 4/2404; H01R 13/506; H01R 13/514; H01R 13/58

(52) U.S. Cl. CPC H01R 4/2404; H01R 13/514; H01R 13/5829; H01R 13/506

(57) ABSTRACT

An insulation piercing connector for piercing a cable positioned therein is provided. The insulation piercing connector includes a base and a cover detachably pivotally connected to the base. The base has a cable slot for positioning and accommodating the cable and a pivoting groove located at a side of the cable slot. The cover includes a conductive piercing member disposed corresponding to the cable slot and a shaft disposed corresponding to pivoting groove. The shaft is inserted into the pivoting groove to form a hinge connection between the cover and the base in a detachable manner, and the conductive piercing member is aligned to the cable. During the process that the cover rotates to cover the base, the conductive piercing member moves toward the cable to pierce the cable.

### CROSS-REFERENCE TO RELATED APPLICATION

This application claims the priority benefit of U.S. provisional application Ser. No. 63/561,706, filed on Mar. 5, 2024. The entirety of the above-mentioned patent application is hereby incorporated by reference herein and made a part of this specification.

### BACKGROUND

### Technical Field

The disclosure relates to a connector, and in particular to an insulation piercing connector.

### Description of Related Art

In the commonly seen electrical connector, the electrical connection between the power or signal cables and the electrical connector is mostly made by welding. However, in some applications, the electrical connector is provided with the blade or needle configured for piercing insulation layer covering the wire to be electrically contacted with the wire, and thus achieving the electrical connection between the power or signal cables and the electrical connector.

In the commonly seen insulation piercing connector, due to the toughness of the insulation layer, it requires considerable time and force to pierce using the blade or needle and results in a higher defective rate for piercing, and thus some improvements are still needed.

### SUMMARY

The disclosure provides an insulation piercing connector, which helps to save time and labor cost as well as enhance accuracy for piercing.

According to an embodiment of the disclosure, an insulation piercing connector is adapted to pierce a cable positioned therein. The insulation piercing connector includes a base and a cover detachably pivotally connected to the base. The base has a cable slot for positioning and accommodating the cable and a pivoting groove located at a side of the cable slot. The cover includes a conductive piercing member disposed corresponding to the cable slot and a shaft disposed corresponding to pivoting groove. The shaft is inserted into the pivoting groove to form a hinge connection between the cover and the base in a detachable manner, and the conductive piercing member is aligned to the cable. During the process that the cover rotates along a first rotating direction to cover the base, the conductive piercing member moves toward the cable to pierce the cable.

In the insulation piercing connector according to an embodiment of the disclosure, the base includes a base snap opposite to the pivoting groove and the cover further includes a cover snap opposite to the shaft. The cover snap is aligned to the base snap. During the process that the cover rotates along the first rotating direction to cover the base, the cover snap move toward the base snap to be engaged with the base snap.

In the insulation piercing connector according to an embodiment of the disclosure, the conductive piercing member is located between the cover snap and the shaft.

In the insulation piercing connector according to an embodiment of the disclosure, a distance between the conductive piercing member and the cover snap is greater than a distance between the conductive piercing member and the shaft.

In the insulation piercing connector according to an embodiment of the disclosure, the base further has an upper side facing the cover, a first lateral side, and a second lateral side, and the first lateral side and the second lateral side are connected to two opposite ends of the upper side. The cable slot extends from the first lateral side to the second lateral side and is recessed from the upper side.

In the insulation piercing connector according to an embodiment of the disclosure, the pivoting groove is located adjacent to the first lateral side and recessed from the upper side, and the base snap is located at the second lateral side.

In the insulation piercing connector according to an embodiment of the disclosure, the base includes a first pivoting portion and a second pivoting portion opposite to the first pivoting portion and the first pivoting portion and the second pivoting portion are located in the pivoting groove. The first pivoting portion is located at an opening of the pivoting groove and the second pivoting portion is located at a bottom of the pivoting groove. The shaft is rotatably clamped between the first pivoting portion and the second pivoting portion.

In the insulation piercing connector according to an embodiment of the disclosure, the first pivoting portion has a concave arc surface facing the bottom of the pivoting groove and the second pivoting portion has an inclined surface facing the opening of the pivoting groove. The shaft rotatably abuts against the concave arc surface and the inclined surface.

In the insulation piercing connector according to an embodiment of the disclosure, an inner wall of the pivoting groove is located at a side of the first pivoting portion and the second pivoting portion. The cover further includes a shaft base from which the shaft protrudes, wherein the shaft base abuts against the inner wall.

In the insulation piercing connector according to an embodiment of the disclosure, a shaft positioning space is defined between the first pivoting portion and the second pivoting portion. During the process that the cover rotates along the first rotating direction to cover the base, the shaft is inserted into the pivoting groove and guided by the second pivoting portion to move into the shaft positioning space. During the process that the cover rotates along a second rotating direction reverse to the first rotating direction to detach from the base, the shaft base pushes against the inner wall to drive the shaft move out of the shaft positioning space.

Based on the foregoing, in the insulation piercing connector according to the embodiments of the disclosure, the cover is detachably pivotally connected to the base. In detail, the hinge connection formed between the cover and the base may be served as a fulcrum, and the cover is adapted to rotate around the fulcrum to cover the base to let the conductive piercing member pierce the insulation layer of the cable. Since the resistance arm formed between the fulcrum and the conductive piercing member is less than the effort arm, less force or effort is required to push the conductive piercing member to pierce the insulation layer of the cable, which leads to save time and labor cost as well as enhance accuracy for piercing.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic view of an insulation piercing connector according to an embodiment of the disclosure.

FIG. 1B is a schematic exploded view of the insulation piercing connector of FIG. 1A.

FIG. 1C is a schematic top view of the insulation piercing connector of FIG. 1A.

FIG. 2A to FIG. 2C are schematic sectional views taken along section line A-A of FIG. 1C illustrating the rotation of the cover.

FIG. 3A to FIG. 3C are schematic sectional views taken along section line B-B of FIG. 1C illustrating the rotation of the cover.

FIG. 4A to FIG. 4C are schematic sectional views taken along section line C-C of FIG. 1C illustrating the rotation of the cover.

### DESCRIPTION OF THE EMBODIMENTS

Reference will now be made in detail to exemplary embodiments of the disclosure, examples of which are illustrated in the accompanying drawings. Wherever possible, the same reference numerals are used in the drawings and description to denote the same or similar parts.

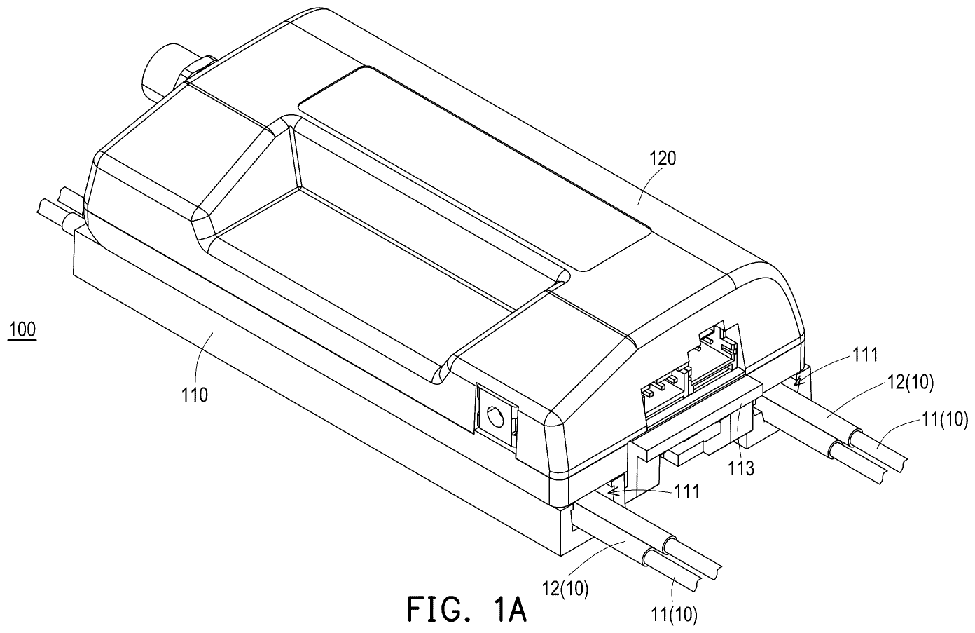

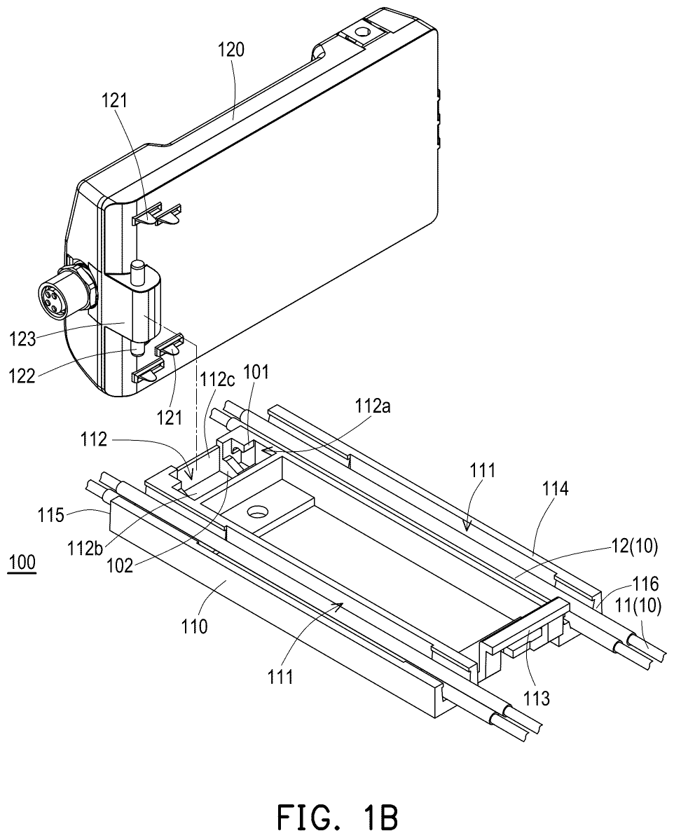

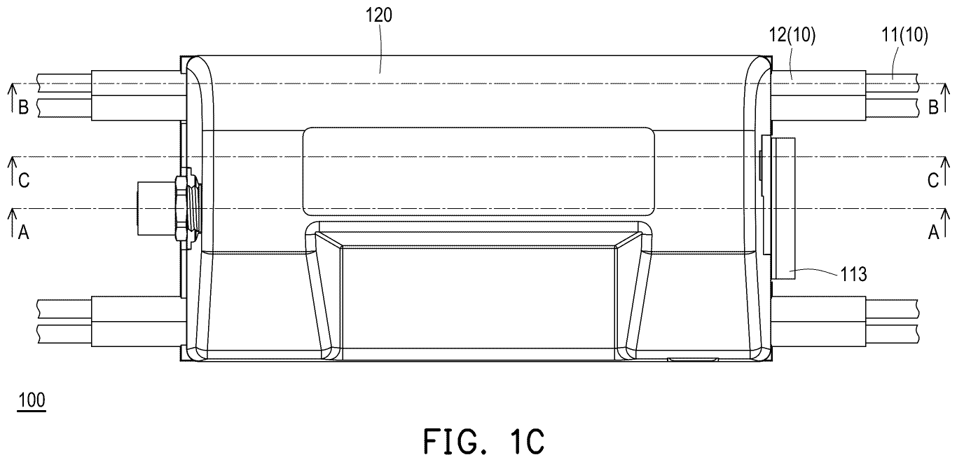

FIG. 1A is a schematic view of an insulation piercing connector according to an embodiment of the disclosure. FIG. 1B is a schematic exploded view of the insulation piercing connector of FIG. 1A. FIG. 1C is a schematic top view of the insulation piercing connector of FIG. 1A. With reference to FIG. 1A to FIG. 1C, in this embodiment, an insulation piercing connector 100 includes a base 110 and a cover 120, wherein the base 110 has at least one cable slot 111 and the cable slot 111 is configured for positioning and accommodating multiple cables 10.

The cover 120 is detachably pivotally connected to the base 110 and includes multiple conductive piercing members 121 protruding from a bottom side facing the base 110. In detail, the conductive piercing members 121 may be multiple conductive blades or multiple conductive needles which are disposed corresponding to the cable slot 111. The end of the moving path of each conductive piercing member 121 is located in the cable slot 111. As such, when the cover 120 rotates to cover the base 110, the conductive piercing members 121 move toward the cable slot 111 and insert into the cable slot 111 to pierce the cables 10 positioned in the cable slot 111, and thus achieving the electrical connection between the cables 10 and the insulation piercing connector 100.

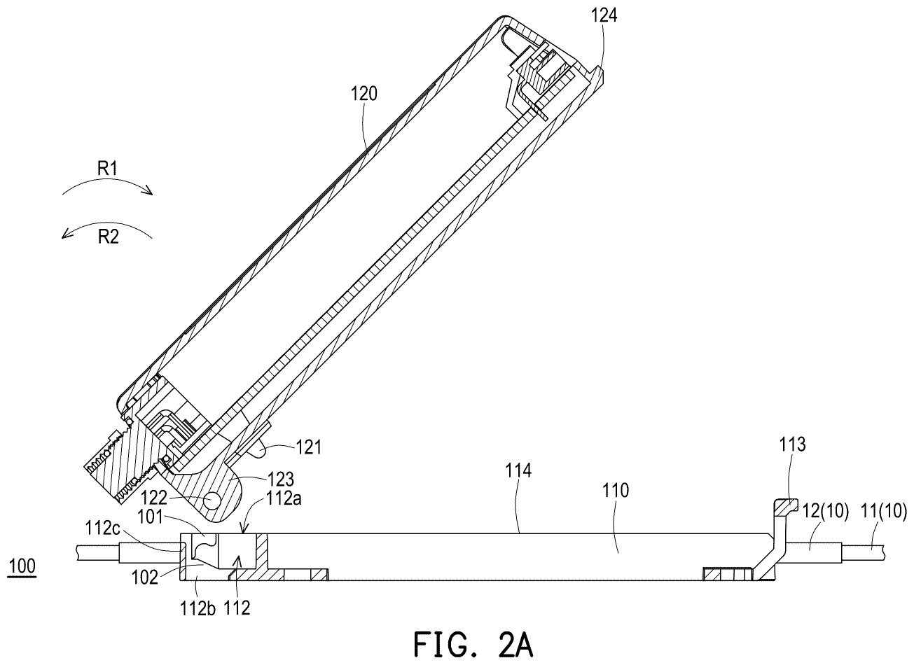

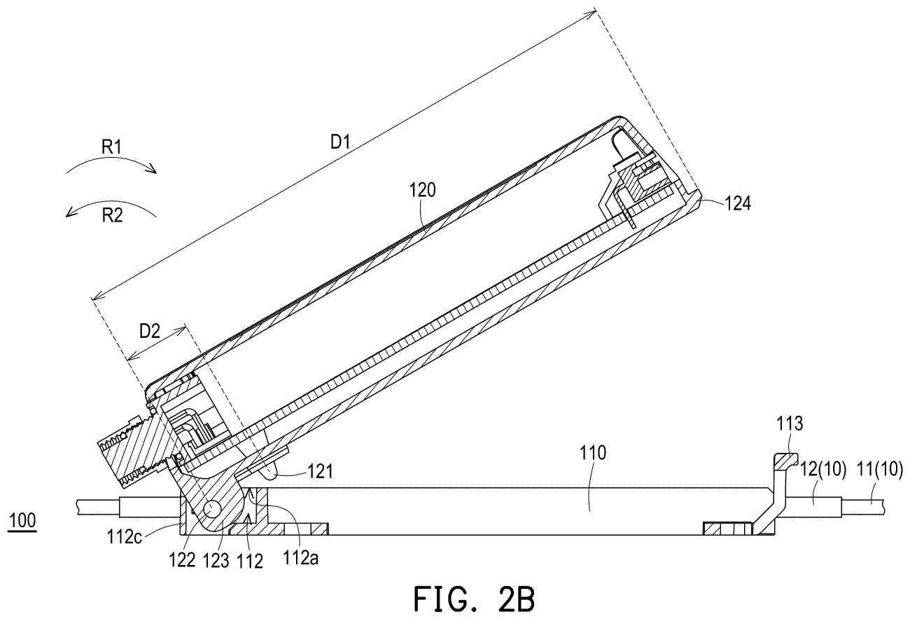

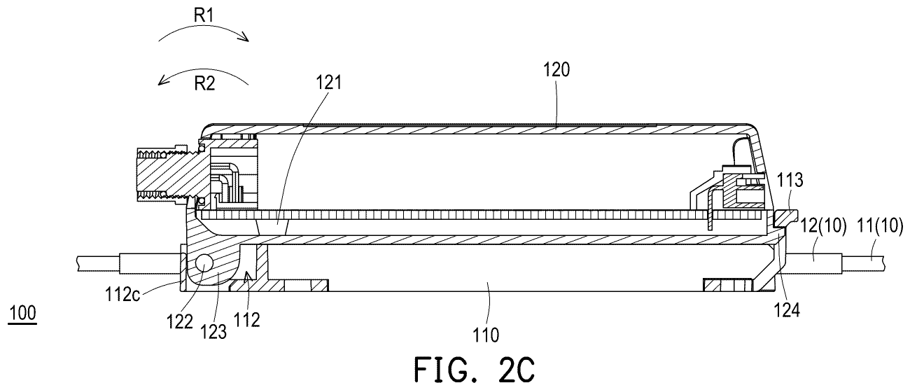

FIG. 2A to FIG. 2C are schematic sectional views taken along section line A-A of FIG. 1C illustrating the rotation of the cover. With reference to FIG. 1B and FIG. 2A to FIG. 2C, the base 110 has a pivoting groove 112 located at a side of the cable slot 111, and the cover 120 includes a shaft 122 and a shaft base 123 which are disposed corresponding to pivoting groove 112. In detail, the pivoting groove 112 is configured for positioning and accommodating the shaft base 123 and the shaft 122 protruding from the haft base 123 and thus forming a hinge connection between the cover 120 and the base 110 in a detachable manner.

For example, the base 110 may be provided with two cable slots 111 which are parallel to each other, and the pivoting groove 112 is located between the two cable slots 111. On the other hand, the cover 120 may be provided with at least four conductive piercing members 121 and each cable slot 111 may be aligned to at least two of the conductive piercing members 121.

As shown in FIG. 2A to FIG. 2C, during the installation process of the cover 120, the shaft base 123 and the shaft 122 protruding from the shaft base 123 are aligned to the pivoting groove 112 and then inserted into the pivoting groove 112 to forming the hinge connection between the cover 120 and the base 110. Afterwards, the cover 120 is able to rotate along a first rotating direction R1 to cover the base 110.

In this embodiment, the base 110 includes a base snap 113 opposite to the pivoting groove 112, and the cover 120 further includes a cover snap 124 opposite to the shaft 122. In detail, the cover snap 124 is aligned to the base snap 113 and the end of the moving path of the cover snap 124 is located at the base snap 113. During the process that the cover 120 rotates along the first rotating direction R1 to cover the base 110, the cover snap 124 move toward the base snap 113 to be engaged with the base snap 113. For example, the cover snap 124 and the base snap 113 may be a combination of a hook and a buckle.

As the cover 120 is secured to the base 110 by the engagement formed between the cover snap 124 and the base snap 113, the cover 120 is unable to rotate along a second rotating direction R2 reverse to the first rotating direction R1, and thus preventing the cover 120 from detaching from base 110 accidentally, which ensures the electrical connection between the cables 10 and the insulation piercing connector 100.

As shown in FIG. 1B and FIG. 2B, the conductive piercing members 121 are located between the cover snap 124 and the shaft 122, where in a distance D1 between any one of the conductive piercing members 121 and the cover snap 124 is greater than a distance D2 between any one of the conductive piercing members 124 and the shaft 122. That is, the conductive piercing members 121 are disposed much closer to the shaft 122 in contrast to the cover snap 124.

As shown in FIG. 1B and FIG. 2A, the base 110 further has an upper side 114 facing the cover 120, a first lateral side 115, and a second lateral side 116. The first lateral side 115 and the second lateral side 116 are connected to two opposite ends of the upper side 114, wherein the cable slot 111 extends from the first lateral side 115 to the second lateral side 116 and is recessed from the upper side 114. On the other hand, the pivoting groove 112 is located adjacent to the first lateral side 115 and recessed from the upper side 114, and the base snap 113 is located at the second lateral side 116.

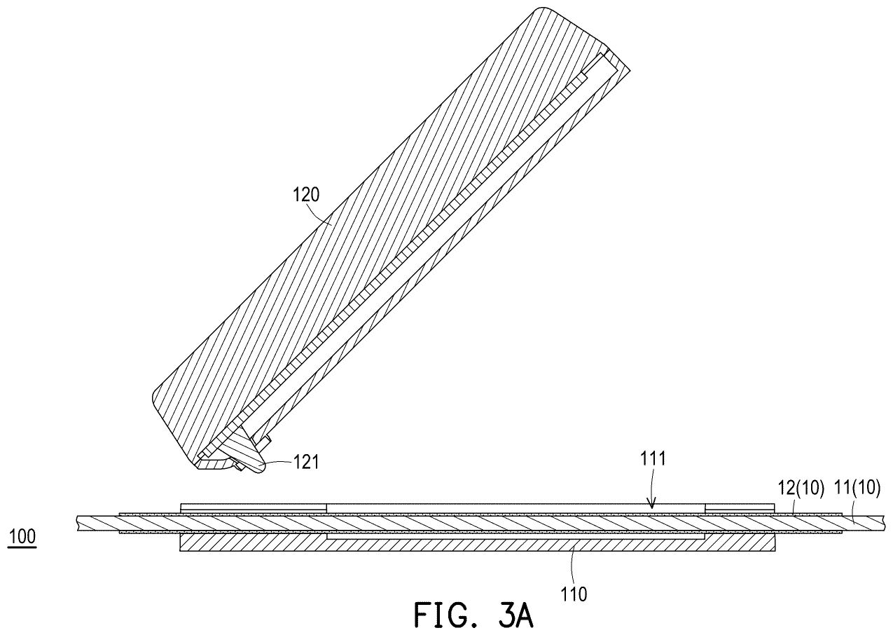

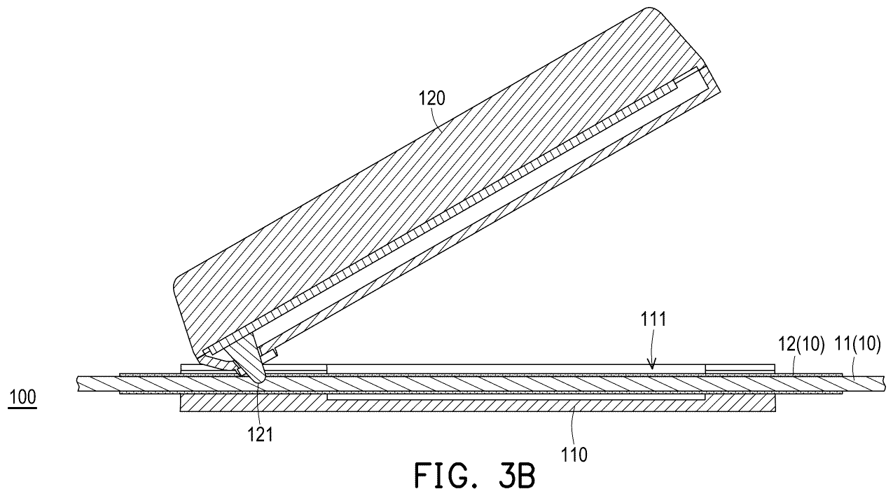

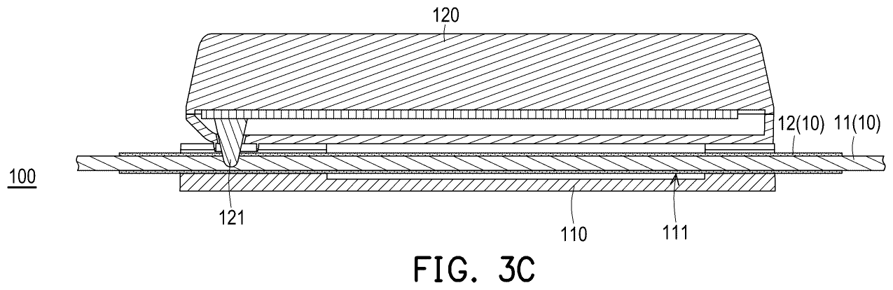

FIG. 3A to FIG. 3C are schematic sectional views taken along section line B-B of FIG. 1C illustrating the rotation of the cover. With reference to FIG. 1B and FIG. 2A to FIG. 2C or FIG. 1B and FIG. 3A to FIG. 3C, as the hinge connection between the cover 120 and the base 110 is formed, the conductive piercing members 121 are aligned to the cables 10 positioned in the cable slot 111. As shown in FIG. 2B, FIG. 2C, FIG. 3B, and FIG. 3C, during the process that the cover 120 rotates along the first rotating direction R1 to cover the base 110, the conductive piercing members 121 move toward the cable slot 111 and insert into the cable slot 111 to pierce the cables 10 positioned in the cable slot 111, and thus achieving the electrical connection between the cables 10 and the insulation piercing connector 100.

In detail, each cable 10 includes a wire 11 and an insulation layer 12 covering the wire 11, and each conductive piercing member 121 pierces the respective insulation layer 12 and thus being electrically contacted with the respective wire 11 as the cover 120 rotates to cover the base 110. Moreover, when each conductive piercing member 121 pierces the respective insulation layer 12 to be electrically contacted with the respective wire 11, the cover 120 is secured to the base 110 by the engagement formed between the cover snap 124 and the base snap 113, and thus preventing the cover 120 from rotating to detach from base 110 accidentally, which ensures the electrical connection between the cables 10 and the insulation piercing connector 100.

As shown in FIG. 2B, FIG. 2C, FIG. 3B, and FIG. 3C, the hinge connection formed between the cover 120 and the base 110 may be served as a fulcrum, and the cover 120 is adapted to rotate around the fulcrum along the first rotating direction R1 to cover the base 110. Since the resistance arm formed between the fulcrum (e.g., shaft 122) and any one of the conductive piercing members 121 is less than the effort arm formed between the fulcrum (e.g., shaft 122) and the cover snap 124, less force or effort is required to push the conductive piercing members 121 to pierce the insulation layers 12 of the cables 10, which leads to save time and labor cost as well as enhance accuracy for piercing.

As shown in FIG. 2A to FIG. 2C or FIG. 3A to FIG. 3C, when the engagement formed between the cover snap 124 and the base snap 113 is removed, the cover 120 is able to be rotated along the second rotating direction R2 and detached from base 110 easily and allows easy replacement of other covers as needed. In detail, since the resistance arm formed between the fulcrum (e.g., shaft 122) and any one of the conductive piercing members 121 is less than the effort arm formed between the fulcrum (e.g., shaft 122) and the cover snap 124, less force or effort is required to pull the conductive piercing members 121 out from the insulation layers 12 of the cables 10.

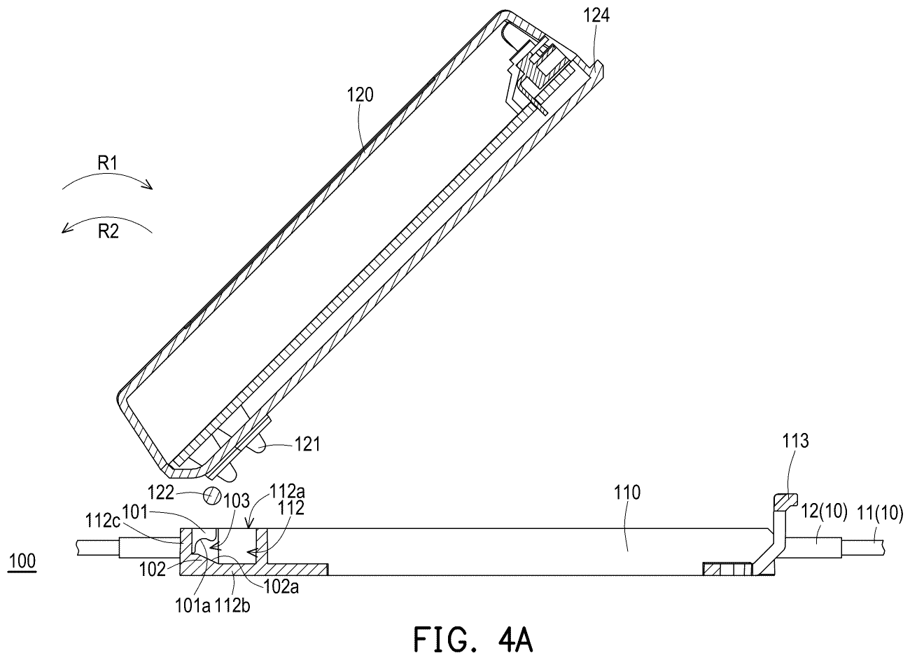

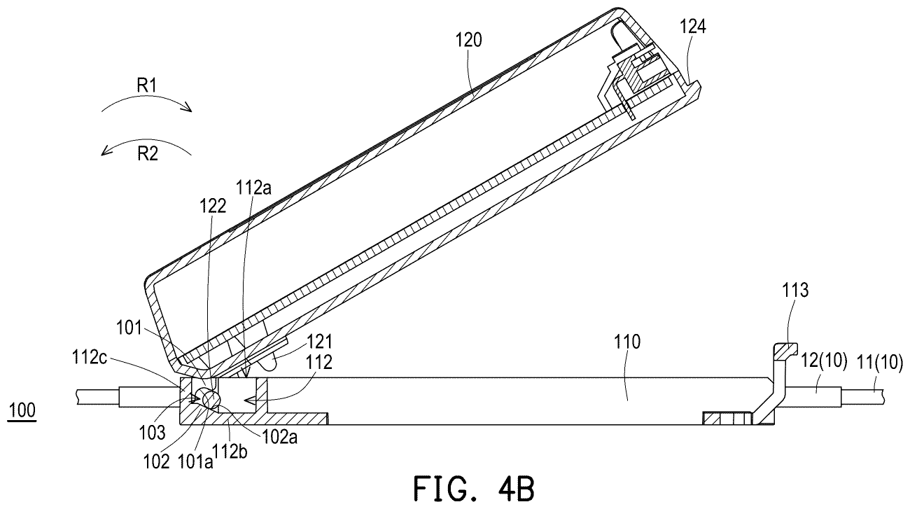

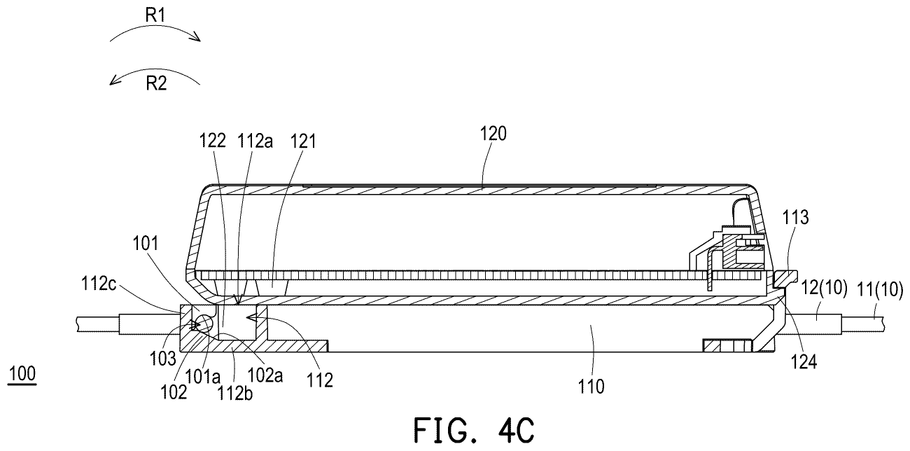

FIG. 4A to FIG. 4C are schematic sectional views taken along section line C-C of FIG. 1C illustrating the rotation of the cover. As shown in FIG. 1B and FIG. 4A, in this embodiment, the base 110 further includes a first pivoting portion 101 and a second pivoting portion 102 opposite to the first pivoting portion 101, and the first pivoting portion 101 and the second pivoting portion 102 are located in the pivoting groove 112. The first pivoting portion 101 is located at an opening 112a of the pivoting groove 112 and the second pivoting portion 102 is located at a bottom 112b of the pivoting groove 112. As shown in FIG. 4B and FIG. 4C, as the hinge connection between the cover 120 and the base 110 is formed, the shaft 122 is rotatably clamped between the first pivoting portion 101 and the second pivoting portion 102.

As shown in FIG. 1B and FIG. 4A, the first pivoting portion 101 has a concave arc surface 101a facing the bottom 112b of the pivoting groove 112, and the second pivoting portion 102 has an inclined surface 102a facing the opening 112a of the pivoting groove 112. In detail, a shaft positioning space 103 is defined between the first pivoting portion 101 and the second pivoting portion 102, and is especially defined between the concave arc surface 101a and the inclined surface 102a. As shown in FIG. 4B and FIG. 4C, as the hinge connection between the cover 120 and the base 110 is formed, the shaft 122 rotatably abuts against the concave arc surface 101a and the inclined surface 102a and is positioned in the shaft positioning space 103.

As shown in FIG. 1B, an inner wall 112c of the pivoting groove 112 is located at a side of the first pivoting portion 101 and the second pivoting portion 102 and may be perpendicular to the bottom 112b of the pivoting groove 112. As shown in FIG. 2A, FIG. 2B, FIG. 4A, and FIG. 4B, firstly, the shaft 122 and the shaft base 123 pass through the opening 112a and insert into the pivoting groove 112. After the shaft 122 and the shaft base 123 insert into the pivoting groove 112, the shaft 122 contacts the inclined surface 102a. As shown in FIG. 2B, FIG. 2C, FIG. 4B, and FIG. 4C, when the cover 120 rotates along the first rotating direction R1 to cover the base 110, the shaft 122 is guided by the inclined surface 102a of the second pivoting portion 102 to move into the shaft positioning space 103, and the shaft base 123 moves toward the inner wall 112c of the pivoting groove 112.

As shown in FIG. 2C and FIG. 4C, as the shaft 122 abuts against the concave arc surface 101a and the inclined surface 102a and is positioned in the shaft positioning space 103, the shaft base 123 abuts against the inner wall 112c of the pivoting groove 112. As shown in FIG. 2A to FIG. 2C or FIG. 4A to FIG. 4C, during the process that the cover 120 rotates along the second rotating direction R2 to detach from the base 110, the shaft base 123 pushes against the inner wall 112c to drive the shaft 122 move out of the shaft positioning space 103 and thus being separated from the concave arc surface 101a and the inclined surface 102a. Afterwards, the shaft 122 and the shaft base 123 may easily pass through the opening 112a and move out of the pivoting groove 112.

In summary of the foregoing, in the insulation piercing connector according to the embodiments of the disclosure, the cover is detachably pivotally connected to the base. In detail, the hinge connection formed between the cover and the base may be served as a fulcrum, and the cover is adapted to rotate around the fulcrum to cover the base to let the conductive piercing members pierce the insulation layers of the cables. Since the resistance arm formed between the fulcrum and any one of the conductive piercing members is less than the effort arm, less force or effort is required to push the conductive piercing members to pierce the insulation layers of the cables, which leads to save time and labor cost as well as enhance accuracy for piercing.

Moreover, when each conductive piercing member pierces the insulation layer to be electrically contacted with the wire, the cover is secured to the base by the engagement formed between the cover snap and the base snap, and thus preventing the cover from rotating to detach from base accidentally, which ensures the electrical connection between the cables and the insulation piercing connector. On the other hand, when the engagement formed between the cover snap and the base snap is removed, the cover is able to be rotated and detached from base easily and allows easy replacement of other covers as needed.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An insulation piercing connector is adapted to pierce a cable positioned therein, wherein the insulation piercing connector comprises:
a base having a cable slot for positioning and accommodating the cable and a pivoting groove located at a side of the least one cable slot; and
a cover detachably pivotally connected to the base, wherein the cover comprises a conductive piercing member disposed corresponding to the cable slot and a shaft disposed corresponding to pivoting groove,
the shaft is inserted into the pivoting groove to form a hinge connection between the cover and the base in a detachable manner, and the conductive piercing member is aligned to the cable,
during the process that the cover rotates along a first rotating direction to cover the base, the conductive piercing member moves toward the cable to pierce the cable.

2. The insulation piercing connector according to claim 1, wherein the base comprises a base snap opposite to the pivoting groove and the cover further comprises a cover snap opposite to the shaft, the cover snap is aligned to the base snap, during the process that the cover rotates along the first rotating direction to cover the base, the cover snap move toward the base snap to be engaged with the base snap.

3. The insulation piercing connector according to claim 2, wherein the conductive piercing member is located between the cover snap and the shaft.

4. The insulation piercing connector according to claim 3, wherein a distance between the conductive piercing member and the cover snap is greater than a distance between the conductive piercing member and the shaft.

5. The insulation piercing connector according to claim 2, wherein the base further has an upper side facing the cover, a first lateral side, and a second lateral side, and the first lateral side and the second lateral side are connected to two opposite ends of the upper side, the cable slot extends from the first lateral side to the second lateral side and is recessed from the upper side.

6. The insulation piercing connector according to claim 5, wherein the pivoting groove is located adjacent to the first lateral side and recessed from the upper side, and the base snap is located at the second lateral side.

7. The insulation piercing connector according to claim 1, wherein the base comprises a first pivoting portion and a second pivoting portion opposite to the first pivoting portion and the first pivoting portion and the second pivoting portion are located in the pivoting groove, the first pivoting portion is located at an opening of the pivoting groove and the second pivoting portion is located at a bottom of the pivoting groove, the shaft is rotatably clamped between the first pivoting portion and the second pivoting portion.

8. The insulation piercing connector according to claim 7, wherein the first pivoting portion has a concave arc surface facing the bottom of the pivoting groove and the second pivoting portion has an inclined surface facing the opening of the pivoting groove, the shaft rotatably abuts against the concave arc surface and the inclined surface.

9. The insulation piercing connector according to claim 7, wherein an inner wall of the pivoting groove is located at a side of the first pivoting portion and the second pivoting portion, the cover further comprises a shaft base from which the shaft protrudes, wherein the shaft base abuts against the inner wall.

10. The insulation piercing connector according to claim 9, wherein a shaft positioning space is defined between the first pivoting portion and the second pivoting portion,
during the process that the cover rotates along the first rotating direction to cover the base, the shaft is inserted into the pivoting groove and guided by the second pivoting portion to move into the shaft positioning space,
during the process that the cover rotates along a second rotating direction reverse to the first rotating direction to detach from the base, the shaft base pushes against the inner wall to drive the shaft move out of the shaft positioning space.
